(19) United States
(12) Patent Application Publication
(10) Pub. No.: US 2018/0297049 A1
(43) Pub. Date: Oct. 18, 2018

(54) LIQUID PUMP DISPENSER

(71) Applicant: Umbra LLC, Buffalo, NY (US)

(72) Inventor: Rong Ma, NingBo City (CN)

(21) Appl. No.: 15/490,234

(22) Filed: Apr. 18, 2017

(51) Int. Cl. B05B 11/04; B05B 11/00; B05B 15/00

(52) U.S. Cl. CPC B05B 11/043; B05B 15/005; B05B 11/004

(57) ABSTRACT

Presented is a liquid fluid dispenser having a container and a large flexible pump head in which air contained within the pump container is used to force the liquid from the pump assemble in the dispensing cycle. The outlet tube is uniform. In one embodiment, a one-way valve extends through the flexible top to enable inflow of air in the recovery phase of the pump cycle. The pump has the advantage of using air as the pumping force medium making it easy to use while the flexible top eliminates the need to prime the dispenser.

### FIELD OF THE INVENTION

The present invention pertains to the field of liquid containers, specifically to containers with a liquid dispensing mechanism, and more specifically to hand operated liquid dispensers OR PUMPS that use air as the pumping force.

### BACKGROUND OF THE INVENTION

Containers that include a liquid dispenser, such as a liquid soap dispenser, are ubiquitous in both the home and the workplace. They are found in factories, laboratories, kitchens, and bathrooms to name just a few typical settings.

In some settings or situations, it is difficult to access or use the hand pump as a user's hands may be contaminated with animal or plant residue, oil, and/or grease making it harder to push on a typical pump that includes a nozzle and storage chamber. Small or relatively narrow pump heads are difficult to operate using wet, slippery, and/or dirty hands. On some occasions, it may be more efficient for the user to press on the pump with a hand that is holding an item, such as dish, but the narrow configuration of the pump head makes it difficult to push on the pump with enough force to pump the soap, water, or other liquid from the container. In addition, if the user is reaching or at an unusual angle, it again may be difficult to push the pump with sufficient force. Finally, such pumps must by pumped several times in order to prime them and to dispense the liquid desired when the empty dispenser is refilled.

What is needed then is a hand operated liquid dispenser that includes a relatively large, easily activated pump activator with a pump mechanism that does not require priming.

### SUMMARY OF THE INVENTION

The present invention broadly comprises a container pump assembly including: a container; a flexible top attached to the container; a nozzle attached to the flexible top; and, a uniform discharge tube having a first end and a second end, wherein the first end is functionally attached to the nozzle and the second end extends proximately to a bottom inner surface of the container. In one embodiment, the nozzle is integral with the flexible top.

In a preferred embodiment, the flexible top has a convex outer surface. In a second preferred embodiment, the continuous discharge tube is uniform and lacks any storage chamber or other structure within the length of the tube. In a third preferred embodiment, the flexible top includes a one-way valve enabling inflow of outside air through the flexible top when the flexible top recovers, i.e. returns to its resting conformation.

One object of the invention is to supply a liquid discharge system that lacks moving parts.

A second object of the invention is to provide a container pump assembly that is inexpensive.

A third object of the invention is to offer a container pump assembly that is easy to operate in a work environment.

### BRIEF DESCRIPTION OF THE SEVERAL VIEWS OF THE DRAWINGS

The nature and mode of the operation of the present invention will now be more fully described in the following detailed description of the invention taken with the accompanying drawing Figures, in which:

FIG. 1 is a cross section view of a dispensing pump known in the prior art that is in the rest position;

FIG. 2 is a top perspective view of the liquid pump assembly of the present invention;

FIG. 3 is a side view of the liquid pump assembly of the present invention;

FIG. 4 is a rear view of the liquid pump assembly depicting a one-way valve in the flexible top of the assembly;

FIG. 5 is a cross section of the liquid pump assembly taken along line 5-5 in FIG. 2;

FIG. 6 is an front perspective view of an exploded diagram of the pump assembly of the present invention portraying how the parts of the pump are attached or fit together;

FIGS. 7A-7C are cross section views of the prior art dispensing pump demonstrating the pumping action that is required to pump liquid from an attached container out through the nozzle of the prior art pump;

FIGS. 8A and 8B are cross section views of the liquid pump assembly of the present invention demonstrating the pumping action of the pump assembly of the present invention; and,

FIG. 8C is a cross section view of the liquid pump assembly depicting the recovery of a flexible top equipped with a one-way valve that enables the inflow of air into the pump assembly.

### DETAILED DESCRIPTION OF EMBODIMENTS OF THE INVENTION

At the outset, it should be appreciated that like drawing numbers on different drawing views identify identical structural elements of the invention. It also should be appreciated that figure proportions and angles are not always to scale in order to clearly portray the attributes of the present invention.

While the present invention is described with respect to what is presently considered to be the preferred embodiments, it is understood that the invention is not limited to the disclosed embodiments. The present invention is intended to cover various modifications and equivalent arrangements included within the spirit and scope of the appended claims.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. It should be appreciated that the term “substantially” is synonymous with terms such as “nearly”, “very nearly”, “about”, “approximately”, “around”, “bordering on”, “close to”, “essentially”, “in the neighborhood of”, “in the vicinity of”, etc., and such terms may be used interchangeably as appearing in the specification and claims. It should be appreciated that the term “proximate” is synonymous with terms such as “nearby”, “close”, “adjacent”, “neighboring”, “immediate”, “adjoining”, etc., and such terms may be used interchangeably as appearing in the specification and claims. Integral in the context of the instant application means that the component parts are formed together as a single unit. Although any methods, devices or materials similar or equivalent to those described herein can be used in the practice or testing of the invention, the preferred methods, devices, and materials are now described.

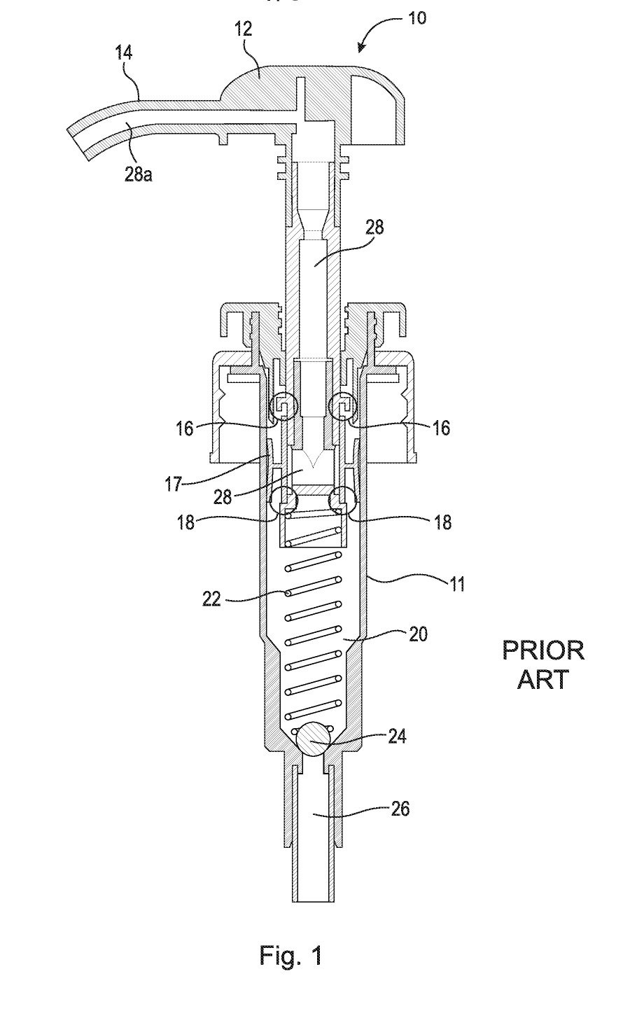

FIG. 1 is a cross section view of dispensing pump 10 in the rest position that is known in the prior art. By rest position is meant that the pump is not in the midst of a pumping cycle, i.e., dispensing liquid or recovering liquid from the container to which it is attached. Pump head 12 includes nozzle 14 and fits into pump body 11 and encloses outlet channel 28 including nozzle channel 28a extending through nozzle 14 to dispense liquid out of the container (not seen). Upper seal 16 is open in the resting position while lower seal 18 is closed by contacting H-seal 17, which slides along the wall of body 11, with an outer ledge of chamber 28.

Spring 22 extends through storage chamber 20 (“chamber 20”). Ball seal 24 seals the opening between chamber 20 and container channel 26 that provides the path for liquid in the container to reach chamber 20 in dispensing pump 10. Outlet channel 28 extends through head 12 with outlet 28a extending through nozzle 14. Chamber 20 and outlet channel 28 hold liquid until it is dispensed or discharged when pump head 12 is pressed toward the container.

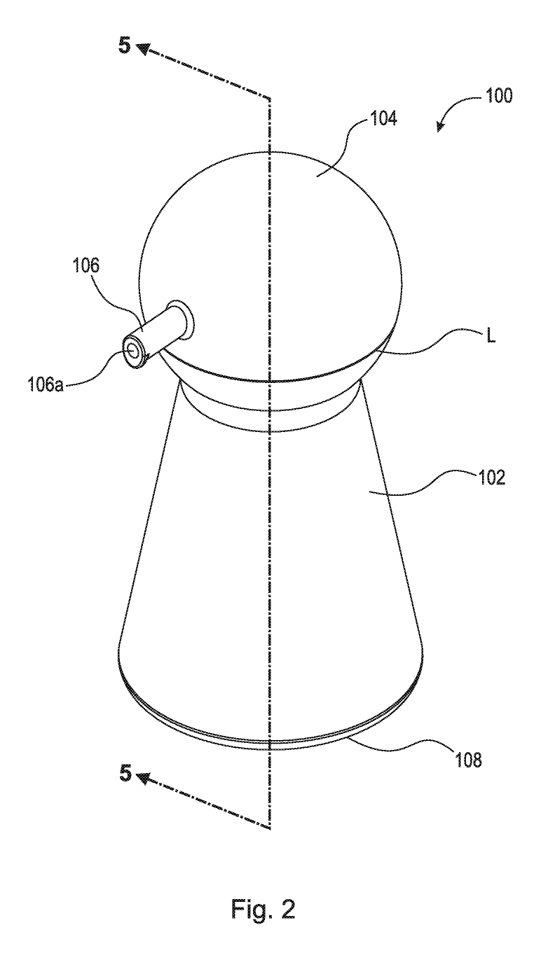

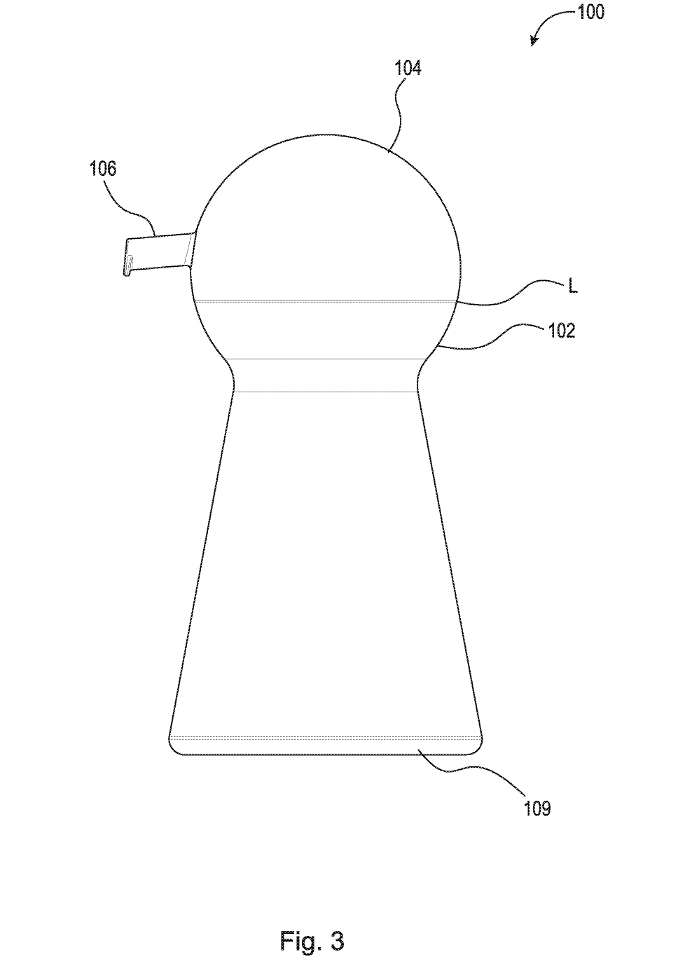

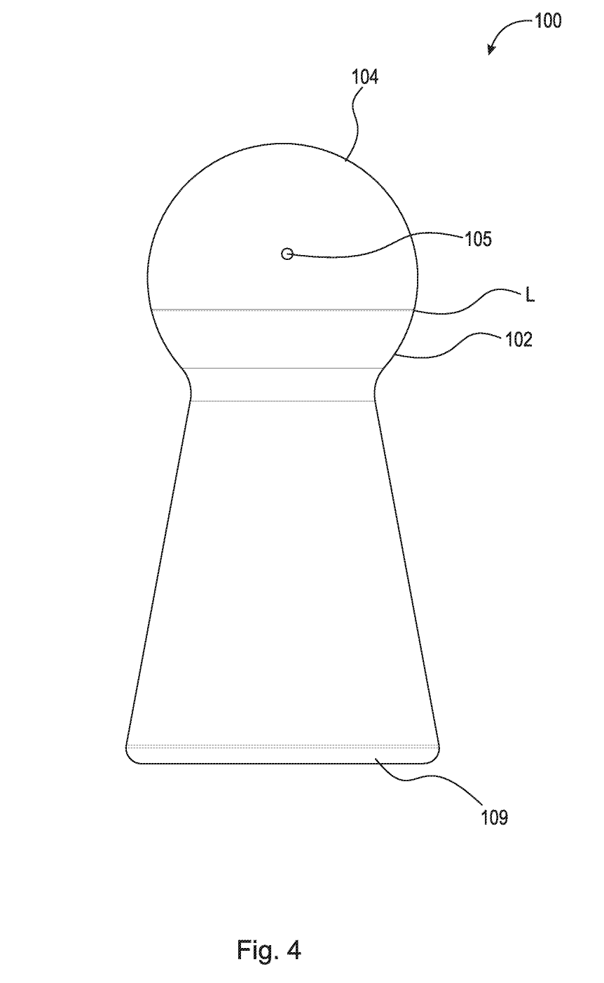

FIG. 2 is a top perspective view of liquid pump assembly 100 (“assembly 100”) of the present invention. Pump head 104 (“head 104”) is attached to container 102 at line L. Nozzle 106 extends from head 104 with liquid dispensed from nozzle channel 106a. In one embodiment, nozzle 106 may be integral with head 104. Integral in this context means that the component parts are formed together as a single unit. FIG. 3 is a side view of assembly 100. FIG. 4 is a rear view of assembly 100 depicting one-way valve 105 which is discussed in detail below.

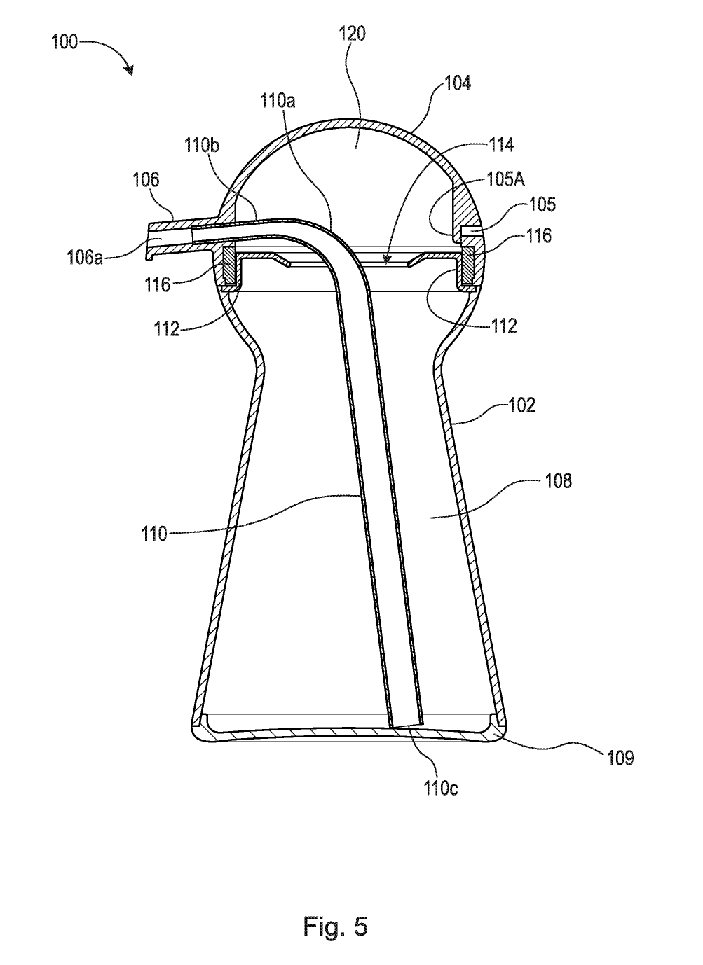

FIG. 5 is a cross section of liquid pump assembly 100 taken along line 5-5 in FIG. 2. Container 102 encloses chamber 108 in which the liquid to be dispensed is stored. End 110c of outlet tube 110 preferably reaches to the inner surface of bottom 109 to dispense as much liquid as possible. End 110c may be beveled. In a preferred embodiment, outlet tube 110 is uniform. Uniform in the context of the instant specification means that no component parts are attached to, integral with, built into, or otherwise associated with outlet tube 110. Examples of component parts include, but are not limited to seals, springs, expanded chambers integral to the tube, moving parts, o-rings, and separate air channels. In the embodiment described, outlet portion 110b is not considered to be a component part in the context of the instant specification and is therefore part of uniform outlet tube 110.

In a preferred embodiment, outlet tube 110 includes curve 110a to reach nozzle 106. In the embodiment shown, outlet tube 110 is functionally attached to nozzle 106. By functionally attached is meant that the link between outlet tube 110 through outlet portion 110b and nozzle 106 allows one of the components to function. In the instant context, the functional attachment between outlet tube 110 and nozzle 106 allows outlet tube 110 to discharge or dispense stored liquid from container 102 to outside pump assembly 100. In the embodiment shown outlet tube 110 is narrowed at outlet portion 110b to extend into nozzle channel 106a in a functional attachment. In an alternate embodiment, outlet portion 110b may extend past the end of nozzle channel 106a or may form the dispensing nozzle of pump head 104 in a functional attachment by extending through an orifice in flexible top 104. In a more preferred embodiment, pump head 104 includes one-way valve 105 (“valve 105”) which includes valve flap 105a (“flap 105a”).

Pump head 104 is preferably flexible and/or easily bent, pushed, pressed, or otherwise manipulated. In a preferred embodiment, the outer surface of head 104 has a shape such as the convex shape shown in FIGS. 2 and 3 so as to enclose a large volume of air or other gas in space 120. Head 104 may be attached directly to the top of container 102 such as by a tight friction fit. In a preferred embodiment as shown in FIG. 5, receiving collar 112 (“collar 112”) is integral with or attached to the top of container 102 and is placed to surround the opening 114 to chamber 108. Receiving collar 112 is releasably attached to attachment ring 116 (“ring 116”). Pump head 104 is attached to the outer surface of attachment ring 116 surrounding opening 114. Receiving collar 112 and attachment ring 116 may be configured to be threadably attached so as to make for efficient attachment and separation. In other configurations, collar 112 and ring 116 may be releasably attached using a friction fit, o-clamp, or other devices and methods known to those skilled in the art. The inner surface of container bottom 109 (“bottom 109”) has a convex shape that allows for draining of liquid toward the outer portion of bottom 109. This draining provides the advantage of dispensing the last portions of the contained liquid by providing tube end 110c access to a shallow pool of residual liquid that may be pumped up the tube. Bottom 109 may be integral with the container or attached as a separate component.

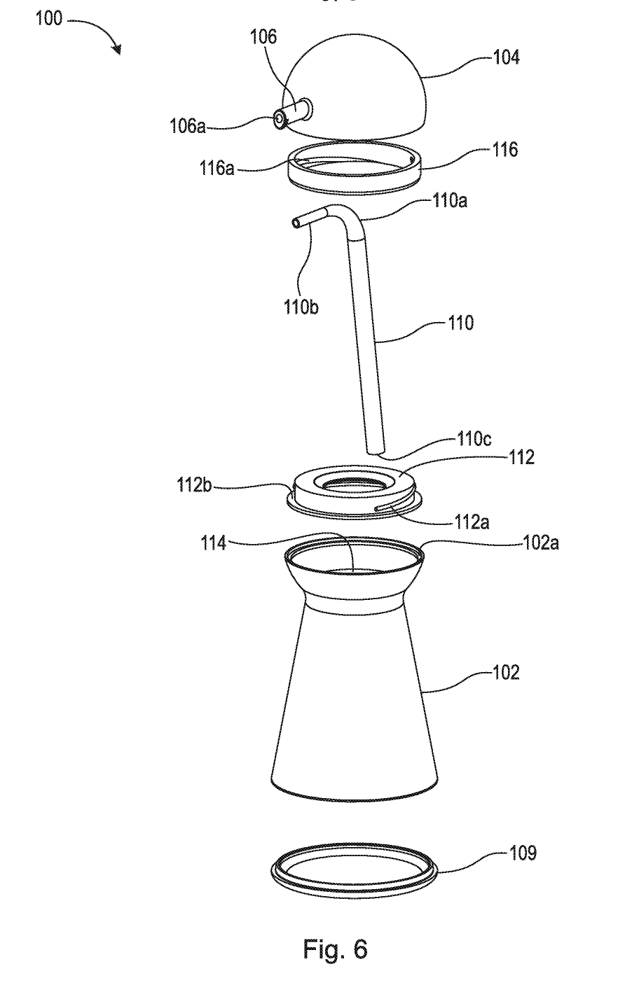

FIG. 6 is an exploded diagram of dispensing pump assembly 100 portraying how the parts described above are attached or fit together. Pump head 104 is shown having the convex shape described above and with attached nozzle 106. Attachment ring 116 is also shown and thread 116a on the inner surface is depicted. Outlet tube 110 will extend through the opening of receiving collar 112 and receiving collar 116 and down through container opening 114. Outer attachment threads 112a are seen that will releasably attach to threads 116a on ring 116.

FIG. 6 portrays the embodiment in which receiving collar ledge 112b rests on lip 102a of container 102. Collar 112 can be attached to container lip 102a using adhesives well known to those having skill in the art. In an alternate embodiment, collar 112 may be integral with the lower portion of container 102. Bottom 109 is fixedly attached to the bottom edge of container 102.

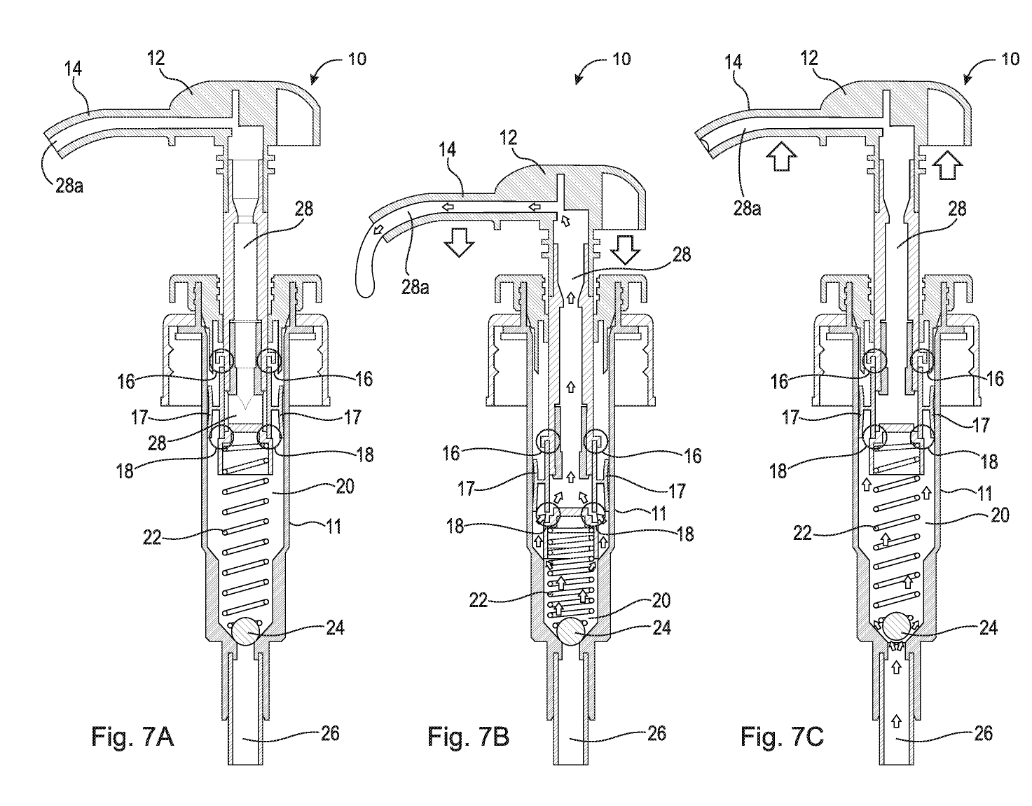

FIGS. 7A-7C are cross section views of prior art dispensing pump 10 demonstrating the pumping cycle that is required to pump liquid from an attached container (not shown) out through nozzle 14. FIG. 7A depicts pump 10 in the rest position, meaning that a pumping cycle is not occurring. In the rest position, upper seal 16 is open while lower seal 18 is closed. Spring 22 is in a noncompressed state inside chamber 20. Ball seal 24 is resting against the narrow opening of container channel 26 into chamber 20. In the resting state, liquid is held in chamber 20 by ball seal 24 and in outlet channel 28 by seal 18.

FIG. 7B depicts the movement of the components of prior art pump 10 when dispensing the liquid stored in chamber 20 and outlet channel 28. Pump head 12 is compressed closing upper seal 16 by contacting H-seal 17. Simultaneously, lower seal 18 is opened by separating from H-seal 17. The downward pressure of pump head 12 forces the liquid in storage chamber 20 to move into outlet 28 through open seal 18 while the liquid in outlet channel 28 is dispensed through nozzle 14. The continued pressure forces the liquid through outlet 28a in nozzle 14.

FIG. 7C portrays the recovery phase in the pump cycle of prior art pump 10. Expanding spring 22 moves pump head 12 upward creating a vacuum in storage chamber 20 which lifts ball seal 24. The vacuum pulls liquid from the attached container (not seen) through channel 26 into chamber 20 and is held in chamber 20 by ball seal 24, which falls back to seal the opening to the container, and lower seal 18 which is again in contact with H-seal 17. Outlet channel 28 holds liquid not dispensed in the previous dispensing phase.

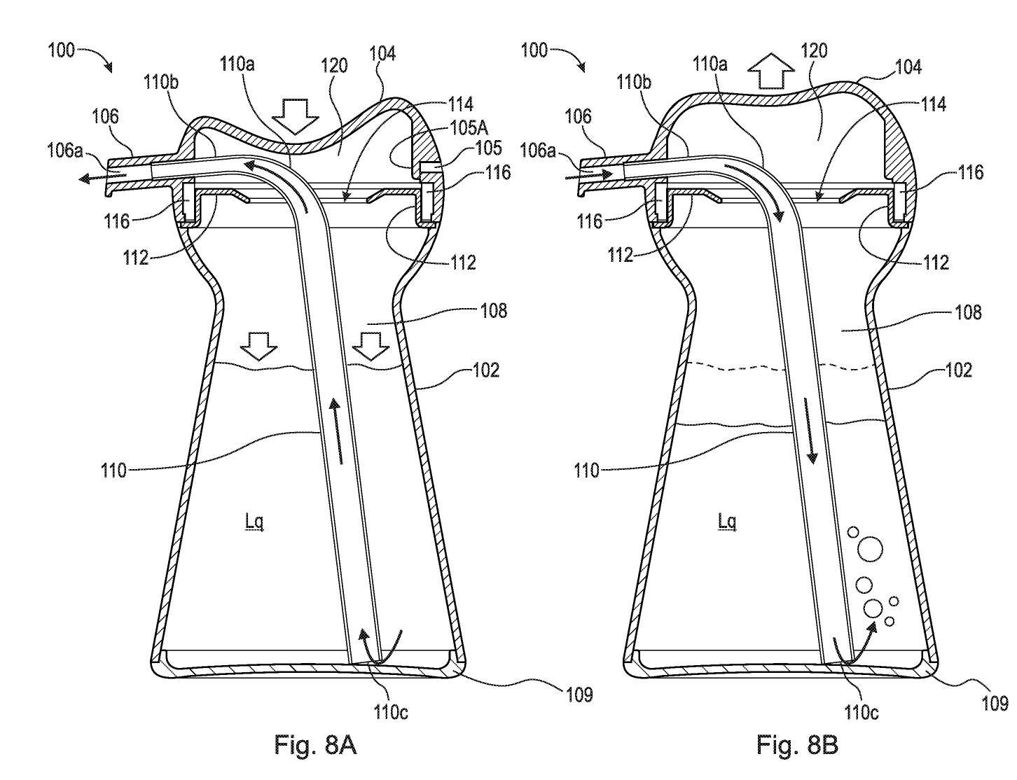

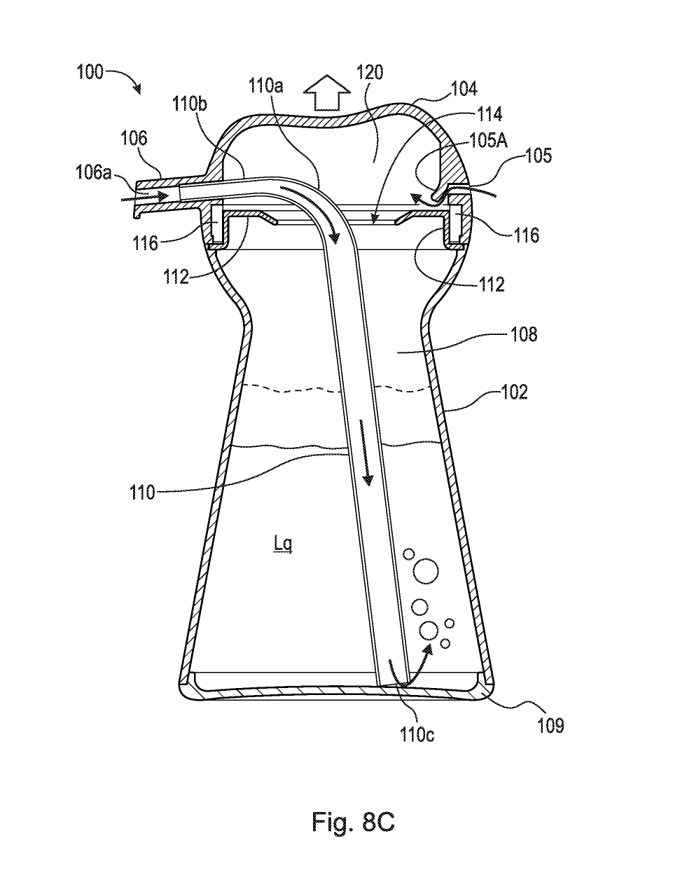

FIGS. 8A, 8B, and 8C are cross section views of liquid pump assembly 100 of the present invention demonstrating the pumping action of pump assembly 100. In the dispensing phase depicted in FIG. 7A, pump head 104 is depressed or squeezed by the user pushing air trapped in container 102 and the inside of head 104 down toward the liquid Lq held in chamber 108. Valve flap 105a is forced close by the compressed or squeezed air thereby preventing escape of the squeezed air from pump assembly 100. As shown by the arrows, downward force of the contained air forces liquid Lq into tube end 110c, up outlet tube 110, and out outlet portion 110b through nozzle 106. Relative to a flat or concave shape, the convex shape of pump head 104 has the advantage of allowing pump head 104 to force a larger amount of air down toward liquid Lq enabling pump assembly to dispense liquid Lq with greater force.

FIG. 8B depicts pump assembly 100 without one-way valve 105 and demonstrates the movement of air back into container 102 as pump head 104 expands to its resting position as seen in FIGS. 2-4. As indicated by the arrows and bubbles, air moves through outlet portion 110b and out tube end 110c into remaining liquid Lq. The dotted line in FIG. 7B represents the level of liquid Lq in chamber 108 and outlet tube 110 before pumping started, while the solid line represents the lower level of liquid Lq remaining in container 108 and tube 110 after the recovery phase. The increased empty space in chamber 108 is filled with an increased amount of air relative to the amount present before the pumping phase commenced. When pump assembly 100 is pumped again, the increased amount of air will effectively dispense the reduced amount of liquid Lq.

FIG. 8C demonstrates the same recovery phase as seen in FIG. 8B with additional intake of air through one-way valve 105 which forces open flap 105a. Use of valve 105 is advantageous with higher viscosity liquid such as liquid soap to allow a greater amount of force to the recovery of flexible top 104 with a subsequent increase in force pulling air through tube 110.

Pump assembly 100 provides several advantages over the prior art described above. In contrast to the prior art pump 10, assembly 100 contains fewer parts making it cheaper and easier to assemble than more complex dispensers such as prior art pump 10 discussed above. In addition, as described above, assembly 100 does not require priming when it is refilled. Moreover, the large flexible pump head 104 makes it easy to use while the use of air rather than the spring and viscous fluid of the prior art pump makes the pump head easier to push. Finally, unlike pump 10, pump 100 does not require priming before dispensing liquid

Thus it is seen that the objects of the invention are efficiently obtained. Although changes and modifications to the invention should be readily apparent to those having ordinary skill in the art, such changes would not depart from the spirit and scope of the invention as claimed.

I claim:

1. A liquid container pump assembly comprising:
a container;
a flexible top releasably attached to said container;
a nozzle attached to said flexible top; and,
a uniform outlet tube having a first end and a second end, wherein said first end is functionally attached to said nozzle and said second end extends proximately to a bottom inner surface of said container.

2. The liquid container assembly as recited in claim 1 further comprising a one-way valve extending through said flexible top.

3. The liquid container pump assembly as recited in claim 1 further comprising a receiving ring around an open top of said container.

4. The liquid container pump assembly as recited in claim 3 wherein said flexible top is attached to said receiving ring.

5. The liquid container pump assembly as recited in claim 4 further comprising a locking ring attached to an inner surface of said flexible top wherein said locking ring is releasably attached to said receiving ring.

6. The liquid container pump assembly as recited in claim 5 wherein said releasable attachment is a threadable attachment.

7. The liquid container pump assembly as recited in claim 1 wherein said second end of said uniform outlet tube is beveled.

8. The liquid container pump assembly as recited in claim 1 wherein said flexible top has an outer surface wherein said outer surface has a convex curve.

9. The liquid container pump assembly as recited in claim 1 wherein said uniform outlet tube includes a curve between said first end and said second end.

10. The liquid container pump assembly as recited in claim 1 wherein said uniform outlet tube lacks a chamber.

11. The liquid container pump assembly as recited in claim 1 wherein said nozzle is integral with said flexible top.

12. A liquid container pump assembly comprising:
a container;
a flexible top releasably attached to said container;
a one-way valve extending through said flexible top;
a nozzle attached to said flexible top; and,
a uniform outlet tube having a first end and a second end, wherein said first end is functionally attached to said nozzle and said second end extends proximately to a bottom inner surface of said container.

13. The liquid container pump assembly as recited in claim 12 further comprising a receiving ring around an open top of said container.

14. The liquid container pump assembly as recited in claim 13 wherein said flexible top is attached to said receiving ring.

15. The liquid container pump assembly as recited in claim 14 further comprising a locking ring attached to an inner surface of said flexible top wherein said locking ring is releasably attached to said receiving ring.

16. The liquid container pump assembly as recited in claim 15 wherein said releasable attachment is a threadable attachment.

17. The liquid container pump assembly as recited in claim 12 wherein said flexible top has an outer surface wherein said outer surface has a convex curve.

18. The liquid container pump assembly as recited in claim 12 wherein said uniform outlet tube includes a curve between said first end and said second end.

19. The liquid container pump assembly as recited in claim 12 wherein said uniform outlet tube lacks a chamber.

20. The liquid container pump assembly as recited in claim 12 wherein said nozzle is integral with said flexible top.
